(19) United States
(12) Patent Application Publication
(10) Pub. No.: US 2014/0132089 A1
(43) Pub. Date: May 15, 2014

(54) LINEAR VIBRATION MOTOR

(71) Applicant: SAMSUNG ELECTRO-MECHANICS CO., LTD., Suwon (KR)

(72) Inventor: Young Jae JEON, Suwon (KR)

(73) Assignee: SAMSUNG ELECTRO-MECHANICS CO., LTD., Suwon (KR)

(21) Appl. No.: 13/830,324

(22) Filed: Mar. 14, 2013

(30) Foreign Application Priority Data
Nov. 12, 2012 (KR) 10-2012-0127566

(51) Int. Cl. H02K 41/03

(52) U.S. Cl. CPC H02K 41/033
USPC 310/14

(57) ABSTRACT

Disclosed herein is a linear vibration motor. The present invention relates to improvement of a magnetic circuit system of the related art in which a magnet is disposed at a central part of an inner space through a yoke and a weight and a coil is disposed centered on the magnet. The linear vibration motor according to the present invention removes the yoke by disposing the weight at the central part of the inner space and horizontally disposing the magnet and the coil centered on the weight to maximally secure the inner space, thereby facilitating the increase in a volume of the magnet, maximizing electromagnetic force, and remarkably improving a response speed.

### CROSS REFERENCE TO RELATED APPLICATION

This application claims the benefit of Korean Patent Application No. 10-2012-0127566, filed on Nov. 12, 2012, entitled “Linear Vibration Motor” which is hereby incorporated by reference in its entirety into this application.

### BACKGROUND OF THE INVENTION

1. Technical Field

The present invention relates to a linear vibration motor.

2. Description of the Related Art

A linear vibration motor, a component that converts electrical energy into mechanical vibration using a generation principle of electromagnetic force is generally mounted in a portable terminal to generate a mute call signal so as to prevent inconvenience to others due to an external sound.

That is, the linear vibration motor is excited by electromagnetic force having a resonance frequency determined using a spring and a motion member suspended from the spring rather than using a rotation principle of a motor to generate vibrations.

In this case, the spring has a constant K value and determines a resonance frequency Fn of the linear vibration motor along with a mass m of the motion member. In addition, the spring formed in a spiral shape so as to facilitate the linear motion of the motion member is generally mounted in a case to elastically support the motion member and then deliver vibrations to a set.

Meanwhile, a linear vibration motor according to the prior art is disclosed in Patent Document 1. That is, according to Patent Document 1, the linear vibration motor according to the prior art configures a magnetic circuit system in which a motion member including a magnet, a yoke, and a weight is vertically disposed between a base plate and a case and a coil is disposed on a substrate at a position corresponding to the magnet to generate a maximum displacement at a resonance point at the time of applying DC or AC current having a constant frequency, thereby causing mechanical vibration.

However, the linear vibration motor according to the prior art, including Patent Document 1 has a limited volume as the magnet generating electromagnetic force by magnetic interaction with the coil is disposed at a center of the motion member, in particular, has a reduced volume corresponding to a size of the yoke as the magnet is disposed in the yoke. Therefore, a response speed for vibrating the motion member at the time of applying current may be degraded as much as the reduced volume of the magnet.

That is, a method for increasing electromagnetic force by improving a magnetic circuit system is effective in increasing a response speed, but it is difficult for the linear vibration motor according to the prior art, including Patent Document 1 to increase electromagnetic force due to a limitation of an inner space of the linear vibration motor in terms of a structure of a motion member.

### PRIOR ART DOCUMENT

### Patent Document

(Patent Document 1) KR2005-0083528 A

### SUMMARY OF THE INVENTION

Therefore, the present invention is to solve a difficulty in the improvement of a response speed due to a limitation of the increase in electromagnetic force that is a problem of the linear vibration motor according to the prior art, including Patent Document 1.

The present invention has been made in an effort to provide a linear vibration motor capable of easily improving a response speed by improving a magnetic circuit system.

According to a preferred embodiment of the present invention, there is provided a linear vibration motor, including: a stator including a bracket and a case assembled in the bracket to form an inner space; a vibration part including a weight disposed to vertically move at a central part of the inner space by an elastomer mounted on the stator; and an armature including a magnet and a coil mounted on each side of the weight and the stator and horizontally disposed centered on the weight.

The magnet may be mounted on the weight and the coil may be mounted on the stator.

The coil may be mounted on the weight and the magnet may be mounted on the stator.

The elastomer may be configured of a pair of coil springs and may be disposed between the upper and lower surfaces of the weight and the stator.

According to another preferred embodiment of the present invention, there is provided a linear vibration motor, including: a stator including a bracket and a case assembled in the bracket to form an inner space; a vibration part including a weight disposed to vertically move at a central part of the inner space by an elastomer mounted on the stator and having a coupling portion formed on a side thereof; and an armature including a magnet and a coil mounted on each side of the weight and the stator and horizontally disposed centered on the weight.

The coupling portion may be formed on a lower side of the weight or may be formed on upper and lower sides of the weight, respectively.

The magnet may be mounted on the weight and the coil may be mounted on the stator.

The coil may be mounted on the weight and the magnet may be mounted on the stator.

According to still another preferred embodiment of the present invention, there is provided a linear vibration motor, including: a stator including a bracket and a case assembled in the bracket to form an inner space; a vibration part including a weight disposed to vertically move at a central part of the inner space by an elastomer mounted on the stator and having a coupling portion formed on a side thereof and displacement portions formed on upper and lower surfaces thereof; and an armature including a magnet and a coil mounted on each side of the weight and the stator and horizontally disposed centered on the weight.

The coupling portion may be formed on a lower side of the weight or may be formed on upper and lower sides of the weight, respectively.

The magnet may be mounted on the weight and the coil may be mounted on the stator.

The coil may be mounted on the weight and the magnet may be mounted on the stator.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are cross-sectional views illustrating a linear vibration motor according to a preferred embodiment of the present invention;

FIGS. 3 and 4 are cross-sectional views illustrating a linear vibration motor according to another preferred embodiment of the present invention; and

FIGS. 5 and 6 are cross-sectional views illustrating a linear vibration motor according to still another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

A linear vibration motor according to a preferred embodiment of the present invention increases a volume of a magnet configuring a magnetic circuit system by maximally securing an inner space formed by a bracket and a case assembled in the bracket to maximize magnetic interaction with a coil, thereby improving a response speed.

For this purpose, the linear vibration motor according to the preferred embodiment of the present invention includes the bracket and the case, as a stator and has an inner space by assembling the case in the bracket. In addition, the linear vibration motor includes a weight disposed at a central part of the inner space, as a vibration part that vertically moves by an elastomer mounted in the inner space to generate mechanical vibration.

In addition, an armature exciting the vibration part with electromagnetic force to generate vibration includes a magnet and a coil and the magnet and the coil that are mounted on each side of the weight and the stator horizontally face each other centered on the weight. In this case, the coil is connected with a printed circuit board and is applied with DC or AC current having a constant frequency.

In this case, the magnet mounted on the weight and the coil mounted on the stator so as to face the magnet may be disposed horizontally and to the contrary, the coil mounted on the weight and the magnet mounted on the stator so as to face the coil may be disposed horizontally.

Therefore, the weight replaces the yoke of the prior art so that the magnet or the coil is disposed in the inner space, thereby maximally securing the inner space. As a result, the inner structure is simplified to maximize the volume of the magnet and maximize the electromagnetic force.

In addition, according to a solution for maximally securing the inner space, an elastomer mounted in the inner space and vertically moving is configured of a pair of coil springs instead of the leaf spring of the prior art and the pair of coil springs is disposed at the central part of the inner space, that is, between the upper and lower spaces of the weight and the stator.

Meanwhile, as described above, a linear vibration motor according to another embodiment of the present invention includes the stator, the vibration part, and the armature and has a structure in which the sides of the weight are provided with coupling portions, the magnet is coupled with the weight through the coupling portions to dispose the coil at the outside of the inner space or the weight is wound with a coil to dispose the magnet at the outside of the inner space.

In this case, the coupling portions are formed on the lower side of the weight or is above and under the side of the weight, respectively, such that the magnet or the coil may be fixed structurally, thereby simplifying the assembling process.

Meanwhile, the linear vibration motor according to still another preferred embodiment of the present invention includes the stator, the vibration part, and the armature as described above and has a structure in which displacement portions are formed on the upper and lower surfaces of the weight. Therefore, the elastic force may be compensated by adopting the coil spring as the elastomer through the displacement portion.

Hereinafter, the preferred embodiment of the present invention will be described below with reference to the accompanying drawings.

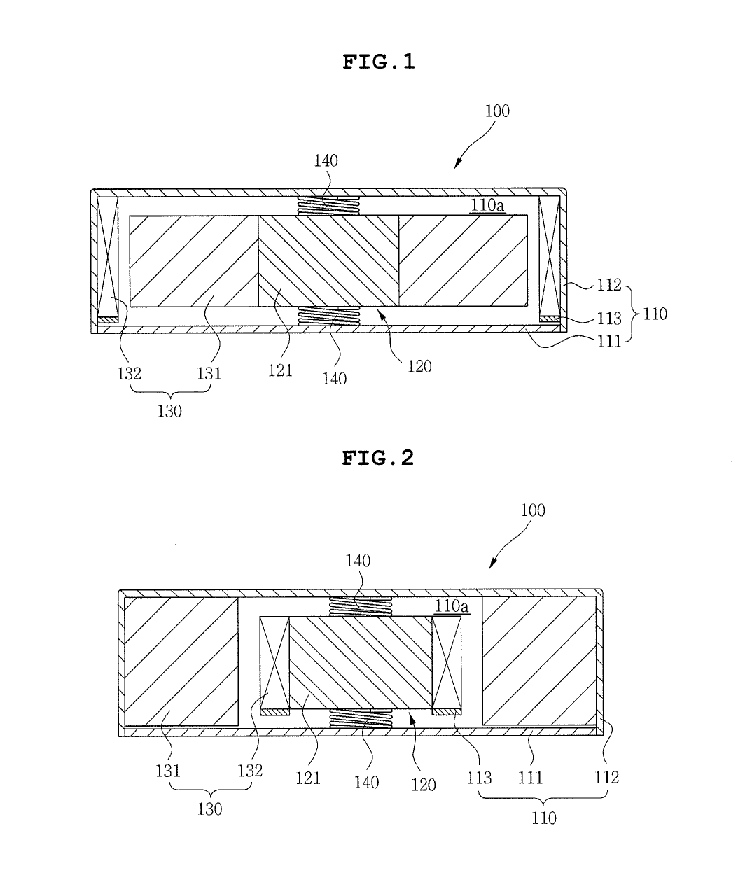

As illustrated in FIGS. 1 and 2, an upper part of a stator 110 is assembled with a case 112 using a bracket 111 as a base, such that the stator 110 has a vibration part 120 and an armature 130 received therein. Further, the central parts of the bracket 111 and the case 112 are each coupled with general coil springs as the elastomers 140 and the weight 121 is disposed between the pair of elastomers 140.

One surface of the case 112 assembled in the bracket 111 has an opened cylindrical shape, and thus the case 112 is assembled on the bracket 111, such that a space is formed in the linear vibration motor 100. The so formed inner space 110a is horizontally provided with the vibration part 120 including the weight 121 and the armature 130 including the magnet 131 and the coil 132.

The weight 121 is formed of a metal material including tungsten so as to easily add a constant mass at the time of forming magnetic field by the armature 130 and ends of the elastomer 140 are each fixed to the upper and lower surfaces of the weight 121 by a spot welding method.

The armature 130 is formed by a method of forming the donut-shaped magnet 131 having a size occupying most of the inner space 110a and coupling the magnet 131 with the side of the weight 121 and winding the coil 132 around the inside of the case 112 so as to face the magnet 131. Further, current is applied to the coil 132 of which the lower part is connected with a flexible printed circuit board (FPCB) as a circuit board 113.

On the other hand, as illustrated in FIG. 2, the armature 130 may be formed by a method of winding the coil 132 around the side of the weight 121 and coupling the magnet 131 with the inside of the case 112 so as to face the coil 132.

In this configuration, the armature 130 mounted on the weight 121 is formed to have a proper height by considering that the weight 121 generates vibration while vertically moving and is formed on the same line as the upper and lower surfaces of the weight 121.

Hereinafter, another preferred embodiment of the present invention will be described below with reference to the accompanying drawings.

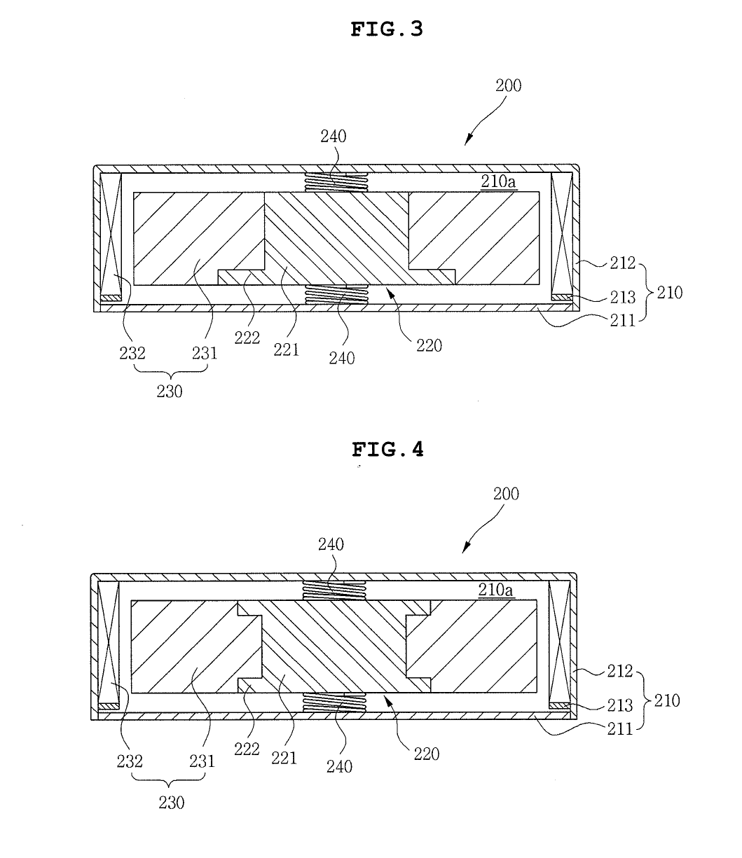

As illustrated in FIGS. 3 and 4, an upper part of a stator 210 is assembled with a case 212 using a bracket 211 as a base, such that the stator 210 has a vibration part 220 and an armature 230 received therein. Further, the central parts of the bracket 211 and the case 212 are each coupled with general coil springs as elastomers 240 and a weight 221 is disposed between the elastomers 240.

One surface of the case 212 assembled in the bracket 211 has an opened cylindrical shape, and thus the case 211 is assembled on the bracket 211, such that a space is formed in a linear vibration motor 200. The so formed inner space 210a is horizontally provided with the vibration part 220 including the weight 221 and the armature 230 including a magnet 231 and a coil 232.

The weight 221 is formed of a metal material including tungsten so as to easily add a constant mass at the time of forming magnetic field by the armature 230 and ends of the elastomers 240 are each fixed to the upper and lower surfaces of the weight 221 by a spot welding method.

Further, coupling portions 222 are formed by protruding the lower side of the weight 221 or formed by protruding the upper and lower sides of the weight 221 and the magnet 231 or the coil 232 is coupled with the weight 221 through the coupling portions 222.

That is, as an example, the magnet 231 is formed in a donut shape having a size occupying most of the inner space 210a and then the inner diameter thereof is formed in a shape corresponding to the coupling portion 222 so as to be coupled with the side of the weight 221. Further, the coil 232 is wound around the outside of the inner space 210a, that is, the inside of the case 212 so as to face the magnet 231 and current is applied to the coil 232 of which the lower part is connected with the flexible printed circuit board (FPCB) as a circuit board 213.

In this configuration, the armature 230 mounted on the side of the weight 221 is formed to have a proper height by considering that the weight 221 generates vibration while vertically moving and is generally formed on the same line as the upper and lower surfaces of the weight 221.

Hereinafter, still another preferred embodiment of the present invention will be described below with reference to the accompanying drawings.

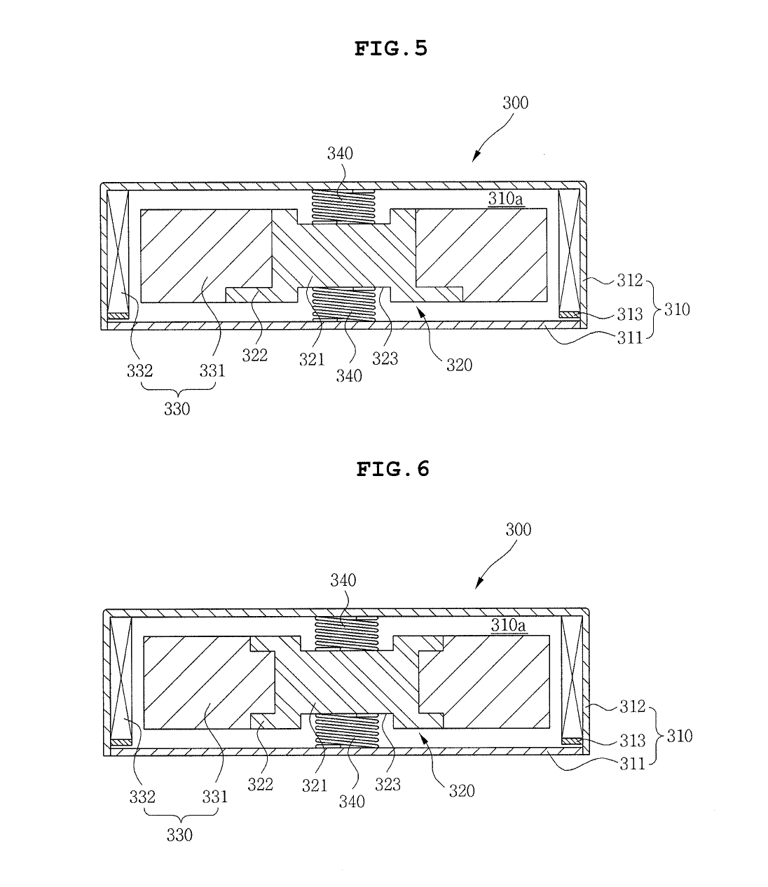

As illustrated in FIGS. 5 and 6, an upper part of a stator 310 is assembled with a case 312 using a bracket 311 as a base, such that the stator 310 has a vibration part 320 and an armature 330 received therein. Further, the central parts of the bracket 311 and the case 312 are each coupled with general coil springs as elastomers 340 and a weight 321 is disposed between the elastomers 340.

One surface of the case 312 assembled in the bracket 311 has an opened cylindrical shape, and thus the case 312 is assembled on the bracket 311, such that a space is formed in a linear vibration motor 300. The so formed inner space 310a is horizontally provided with the vibration part 320 including a weight 321 and the armature 330 including a magnet 331 and a coil 332.

The weight 321 is formed of a metal material including tungsten so as to easily add a constant mass at the time of forming magnetic field by the armature 330 and grooves as displacement portions 323 are formed on the upper and lower surfaces of the weight 321 and then ends of elastomers 340 received in the displacement portions 323 are fixed thereto by a spot welding method.

Further, coupling portions 322 are formed by protruding the lower side of the weight 321 or formed by each protruding the upper and lower sides of the weight 321 and the magnet 331 or the coil 332 is coupled with the weight 321 through the coupling portions 322.

That is, as an example, the magnet 331 is formed in a donut shape having a size occupying most of the inner space 310a and then the inner diameter thereof is formed in a shape corresponding to the coupling portion 322 so as to be coupled with the side of the weight 321. Further, the coil 332 is wound around the outside of the inner space 310a, that is, the inside of the case 312 so as to face the magnet 331 and current is applied to the coil 332 of which the lower part is connected with the flexible printed circuit board (FPCB) as a circuit board 313.

In this configuration, the armature 330 mounted on the side of the weight 321 is formed to have a proper height by considering that the weight 321 generates vibration while vertically moving and is generally formed on the same line as the upper and lower surfaces of the weight 321.

The present invention relates to the improvement in the magnetic circuit system according to the prior art in which the magnet is disposed at the central part of the inner space. More particularly, according to the preferred embodiments of the present invention, the magnetic circuit system has a structure in which the weight is disposed at the central part of the inner space and the magnet and the coil are horizontally disposed centered on the weight to facilitate the increase in the volume of the magnet, thereby maximizing the electromagnetic force and remarkably improving the response speed.

Further, the weight can replace the function of the yoke of the prior art to reduce the number of components and simplify the structure, thereby maximally securing the inner space and increasing the volume of the magnet.

In addition, the side of the weight is provided with the coupling portion to selectively have the magnet or the coil, thereby simplifying the assembling process and saving the manufacturing costs.

Moreover, instead of the leaf spring of the prior art, the coil springs adopted as the elastomer are disposed on the upper and lower surfaces of the weight to minimize the area of the elastomer occupied in the inner space, thereby maximally securing the inner space and increasing the volume of the magnet.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A linear vibration motor, comprising:
a stator including a bracket and a case assembled in the bracket to form an inner space;
a vibration part including a weight disposed to vertically move at a central part of the inner space by an elastomer mounted on the stator; and
an armature including a magnet and a coil mounted on each side of the weight and the stator and horizontally disposed centered on the weight.

2. The linear vibration motor as set froth in claim 1, wherein the magnet is mounted on the weight and the coil is mounted on the stator.

3. The linear vibration motor as set froth in claim 1, wherein the coil is mounted on the weight and the magnet is mounted on the stator.

4. The linear vibration motor as set froth in claim 1, wherein the elastomer is configured of a pair of coil springs and is disposed between the upper and lower surfaces of the weight and the stator.

5. A linear vibration motor, comprising:
a stator including a bracket and a case assembled in the bracket to form an inner space;
a vibration part including a weight disposed to vertically move at a central part of the inner space by an elastomer mounted on the stator and having a coupling portion formed on a side thereof; and
an armature including a magnet and a coil mounted on each side of the weight and the stator and horizontally disposed centered on the weight.

6. The linear vibration motor as set froth in claim 5, wherein the coupling portion is formed on a lower side of the weight or is formed on upper and lower sides of the weight, respectively.

7. The linear vibration motor as set froth in claim 6, wherein the magnet is mounted on the weight and the coil is mounted on the stator.

8. The linear vibration motor as set froth in claim 6, wherein the coil is mounted on the weight and the magnet is mounted on the stator.

9. A linear vibration motor, comprising:
a stator including a bracket and a case assembled in the bracket to form an inner space;
a vibration part including a weight disposed to vertically move at a central part of the inner space by an elastomer mounted on the stator and having a coupling portion formed on a side thereof and displacement portions formed on upper and lower surfaces thereof; and
an armature including a magnet and a coil mounted on each side of the weight and the stator and horizontally disposed centered on the weight.

10. The linear vibration motor as set froth in claim 9, wherein the coupling portion is formed on a lower side of the weight or is formed on upper and lower sides of the weight, respectively.

11. The linear vibration motor as set froth in claim 10, wherein the magnet is mounted on the weight and the coil is mounted on the stator.

12. The linear vibration motor as set froth in claim 10, wherein the coil is mounted on the weight and the magnet is mounted on the stator.
